(19) United States
(12) Patent Application Publication
(10) Pub. No.: US 2016/0113265 A1
(43) Pub. Date: Apr. 28, 2016

(54) FUMIGATION APPARATUS AND METHODS THEREOF

(71) Applicant: Lanodir USA, Inc., Bethesda, MD (US)

(72) Inventors: Alvaro Sorrondeguy, Bethesda, MD (US); Pablo Jose Canabez Berthet, Montevideo (UY); Martin Marques, Asuncion (PY)

(73) Assignee: Lanodir USA, Inc., Bethesda, MD (US)

(21) Appl. No.: 14/523,883

(22) Filed: Oct. 25, 2014

(51) Int. Cl. A01M 13/00; B63B 69/00

(52) U.S. Cl. CPC A01M 13/003; B63B 69/00

(57) ABSTRACT

A fumigation apparatus and methods thereof. The apparatus may include a first conduit segment to extend between a load portion of a cargo vessel chamber and a support portion of the cargo vessel chamber opposite the load portion. The apparatus may also include a second conduit segment coupled with the first conduit segment to extend over the support portion between opposing sidewalls of the cargo vessel chamber. In one example, the second conduit segment may include a plurality of apertures to allow a fumigant that is to be injected to the first conduit segment to be ejected from the second conduit segment. The fumigant may include a gas, such as phosphine gas.

### BACKGROUND

Embodiments generally relate to a fumigation apparatus and methods thereof. More particularly, embodiments may relate to a fumigation apparatus disposed in a cargo vessel to fumigate cargo (e.g., a commodity) transported in the cargo vessel.

Fumigation technologies may require that a fumigation apparatus be permanently integrated with a structure holding a commodity (e.g., a silo), which may minimize versatility and/or maximize installation and maintenance expenditures. Fumigation technologies may also require a relatively large number of tablets (e.g., beads) to be manually distributed into a top surface of the commodity (e.g., 2-3 meters (m) deep) using a probe. The tablets may immediately begin to liberate a fumigant, require the application of a sheet (e.g., plastic, nylon) on the top surface, and/or completely liberate the fumigant after 36 hours. A fan may move the liberated fumigant by drawing the fumigant from the top surface to a bottom surface of the commodity.

Accordingly, fumigation technologies may provide relatively slow distribution (e.g.,5 hours for thousands of metric tons of commodity), a relatively long time for an effective concentration, a waste of resources (e.g., power, tablets), etc. Also, a relatively large of amount of protective gear and/or workers (e.g., 20 workers) may be required. In addition, tablets may react with humidity, temperature, etc., to generate toxic and/or flammable residues that need to be separated from the commodity or that prevent use for a variety of commodities (e.g., fruits). Moreover, tablets may not liberate all of the fumigant, or additional time may be required before unloading to achieve a safe fumigant level. Also, tablets may not liberate the fumigant under certain conditions (e.g., at or below 10° C. and 40% humidity), which may prevent use for a variety of commodities (e.g., fruit) or environments without relatively complex control mechanisms.

### BRIEF DESCRIPTION OF THE DRAWINGS

The various advantages of the embodiments will become apparent to one skilled in the art by reading the following specification and appended claims, and by referencing the following drawings, in which:

FIGS. 1A-1C are diagrams of an example of a fumigation apparatus according to an embodiment;

FIGS. 2A-2B are diagrams of an example of a conduit segment according to an embodiment; and

FIG. 3 is a graph of an example of a fumigant concentration profile according to an embodiment.

### DETAILED DESCRIPTION

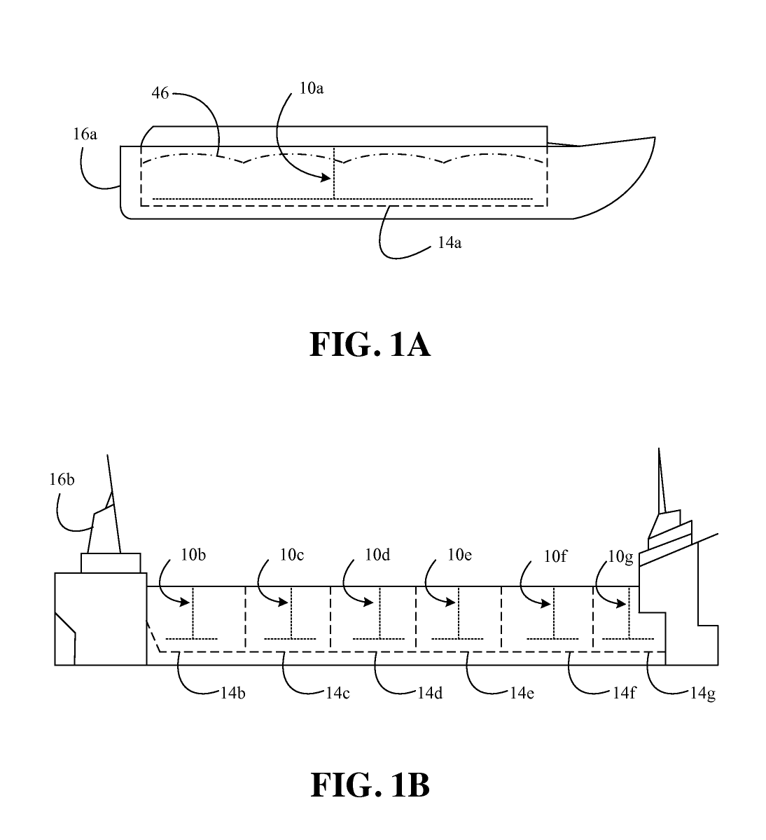

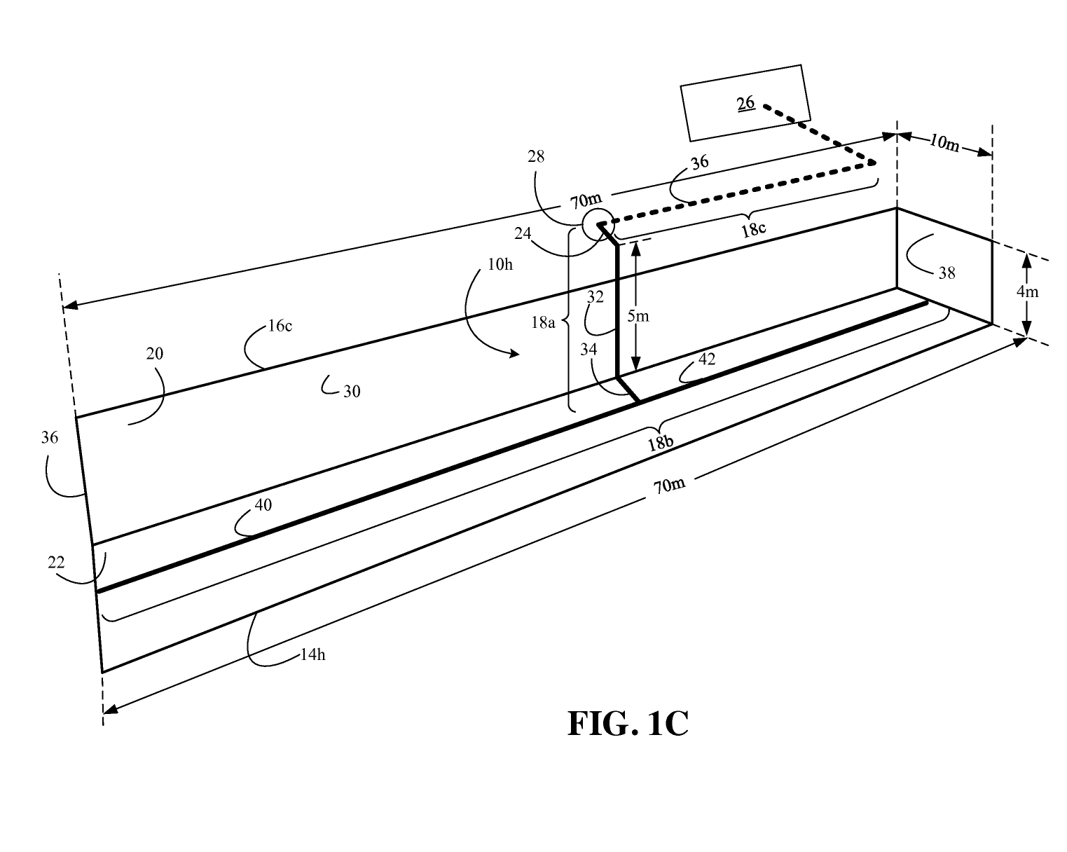

FIGS. 1A-1C show a fumigation apparatus 10 (10 a-10 h) according to an embodiment, which may be disposed in a cargo vessel chamber 14 (14a-14h) of a cargo vessel 16(16a-16c). The cargo vessel 16 may include a cargo water vessel such as, for example, a barge, a cargo ship, and so on. Generally, a barge may refer to a vessel for river and/or canal transport of cargo. Barges may be self-propelled, may be propelled by tugboats (e.g., towed), by towboats (e.g., pushed), and so on. As illustrated in FIG. 1A, a fumigation apparatus 10 a is disposed in a cargo hold 14a of a barge 16a. A cargo ship (or a freighter ship) may refer to any ship or vessel that carries cargo from one port to another, such as a bulk carrier. A dry bulk carrier, for example, may refer to an ocean-going vessel used to transport bulk cargo (e.g., grain, fruit). Dimensions of a bulk carrier may vary based on a port served, a route served, and so on. For example, a lake freighter may be utilized when the route served includes a relatively small lake. As illustrated in FIG. 1B, a plurality of fumigation apparatuses 10b-10g are disposed in a plurality of cargo holds 14b-14g, respectively, of a cargo ship 16b.

The cargo vessel 16 may include one or more hatch covers designed to automatically slide outboard or fold fore-and-aft for loading and unloading cargo. For example, the cargo vessel 16 may be opened and closed using a hatch cover that moves in a fore and aft direction (e.g., folding hatch cover) or athwartships (e.g., sliding hatch cover). In one example, a steel hatch cover may fold, slide, roll, etc., by a hydraulic or an electric system. Such hatch covers may be fitted with securing devices to make them weathertight. Hatch covers may also be manually movable. In one example, gantries may lift portable hatch covers for loading and unloading cargo. Such portable hatch covers may be made weathertight by cleats, cross joint wedges, and so on. In addition, hatch covers may include a removable portion used to expose the cargo without moving the entire hatch cover. For example, the removable portion may be removed to inspect the cargo before moving the hatch cover to unload the cargo.

As illustrated in FIG. 1C, a fumigation apparatus 10h may include a conduit segment 18 (18a-18c), which may be disposed in a cargo vessel chamber 14h of a cargo vessel 16c. The conduit segment 18 may be designed and/or selected to include a material with appropriate properties (e.g., stress, strain) to accommodate an intended application such as, e.g., cargo type, temperature, pest type, and so on. For example, the conduit segment 18 may be formed of any material that is mechanically stable enough to support a relatively large weight (e.g., approximately 1,500 metric tons of cargo, approximately 3,000 metric tons of cargo). The conduit segment 18 may be formed of a polymer material such as, for example, polyvinyl chloride (PVC). In this case, the conduit segment 18 may be disposable and/or discarded after fumigation. Thus, there may be no requirement to permanently integrate the fumigation apparatus 10 with the cargo vessel 16. The conduit segment 18 may also be formed of a metal material, such as an alloy, which may be reused and/or saved. In addition, the conduit segment 18 may be designed and/or selected to include any cross-sectional geometry such as, e.g., a round cross-section, an oval cross-section, a square cross-section, a rectangular cross-section, a hexagonal cross-section, a star cross-section, and so on.

In the illustrated example, a first conduit segment 18a may extend between a load portion 20 of the cargo vessel chamber 14h and a support portion 22 of the cargo vessel chamber 14h opposite the load portion 20. Generally, the load portion 20 may refer to an area of the cargo vessel chamber 14h that provides access for cargo loading and/or unloading, and the support portion 22 may refer to an area of the cargo vessel chamber 14h that supports the cargo (e.g., weight of the cargo). Thus, the first conduit segment 18a may be accessible when a manually movable cover and/or an automatically moveable cover (e.g., a hatch cover) is moved to reveal the first conduit segment 18a, when a removable portion is removed to reveal the first conduit segment 18a, and so on.

The first conduit segment 18a may include an influent segment 24 to couple the first conduit segment 18a with a fumigant system 26. In one example, the influent segment 24 may directly couple with the fumigant system 26. For example, the influent segment 24 may be directly accessed (e.g., coupled) by the fumigant system 26 across a cover (e.g., a hatch cover) for the cargo vessel chamber 14h, an opening 28 at a sidewall of the cargo vessel chamber 14h, and so on. The opening 28 may include a cap (e.g., a door) to cover the first conduit segment 18a when access is not needed. In one example, the opening 28 may be utilized for a barge having a sliding hatch that sequentially closes as a predetermined area of a cargo vessel chamber is filled. The influent segment 24 may also be indirectly accessed by the fumigant system 26 through a third conduit segment 18c disposed external to the cargo vessel chamber 14h. The third conduit segment 24 may be temporarily fixed to an outer surface of the cargo vessel 16c and run between the influent segment 24 and the fumigant system 26, which may also be disposed external to the cargo vessel chamber 14h (e.g., at a dock, in a transport vehicle, etc.)

The first conduit segment 18a may also include an intermediate segment 32 to extend substantially vertically between the load portion 20 and the support portion 22. In one example, the intermediate segment 32 may be disposed at (e.g., on, adjacent) a sidewall 30 of the cargo vessel chamber. In another example, the intermediate segment 32 may be disposed proximate to a central area of the cargo vessel chamber 14h (e.g., through the middle of cargo). The first conduit segment 18a may also include a coupler segment 34 to couple the first conduit segment a with a second conduit segmentb. The coupler segment 34 may be molded with the second conduit segment 18b to couple the first conduit segment 18a with the second conduit segment 18b. The coupler segment 34 may also include a mechanical coupler and/or a chemical coupler to couple the first conduit segment 18a with the second conduit segment 18b. For example, the coupler may include a mechanical threaded coupler, a screw coupler, a bolt coupler, a latch coupler, a rail coupler, an adapter, an elbow, a fitting, and so on. The coupler may also include a chemical adhesive coupler, a chemical solder coupler, and so on.

The first conduit segment 18a may be designed and/or selected to include any desired shape. As illustrated in FIG. 1C, the influent segment 24 may be a top part of a Z shape, the intermediate segment 32 may be an intermediate part of the Z shape, and the coupler segment 34 may be a bottom part of the Z shape. As illustrated in FIGS. 1A and 1B, an influent segment may be a top part of an l shape, an intermediate segment may be an intermediate part of the l shape, a coupler segment may be a bottom part of the l shape, wherein all of the segments may extend substantially vertically between a load portion and a support portion. In another example for an L shape, an influent segment may be similar to the influent segment 24 of the Z shape (FIG. 1C), discussed above, and an intermediate segment and a coupler segment may be similar to the intermediate segment and the coupler segment of the l shape (FIGS. 1A and 1B), discussed above. Alternatively for an L shape, an influent segment and an intermediate segment may be similar to the influent segment and the influent segment of the l shape (FIGS. 1A and 1B), discussed above, and a coupler segment may be similar to the coupler segment 34 of the Z shape (FIG. 1C), discussed above. Thus, any shape is contemplated, including a C shape, an O shape, a step shape (e.g., horizontally, vertically), and so on.

In the illustrated example, the second conduit segment 18b may be coupled with the first conduit segment 18a to extend over the support portion 22 between sidewalls 36, 38 of the cargo vessel chamber 14h. The second conduit segment 18b may include a plurality of apertures, discussed below, to allow a fumigant that is injected to the first conduit segment 18a to be ejected from the second conduit segment 18b. For example, the fumigant may be injected to the influent segment 24 from the fumigant system 26 and/or the third conduit segment 18c, and may unidirectionally flow out of the coupler segment 34 to the second conduit segment 18b to be ejected therefrom. In one example, the second conduit segment 18b may be disposed on a floor the cargo vessel chamber 14h before cargo is loaded, wherein the floor is a boundary of the support portion 22. In another example, a predetermined amount of cargo may be loaded and the second conduit segment 18b may be disposed on the cargo above the floor of the support portion 22 before a remainder of the cargo is loaded.

The second conduit segment 18b may include a first distribution segment 40 to extend from the first conduit segment 18a in a substantially horizontal direction towards a first sidewall 36 of the cargo vessel chamber 14h, and a second distribution segment 42 to extend from the first conduit segment 18a in substantially horizontal direction towards a second sidewall 38 opposite the first sidewall 36. In the illustrated example, the first distribution segment 40 and the second distribution segment 42 extend from the coupler segment 34 of the first conduit segment 18a. The second conduit segment 18b may span the entire length or substantially the entire length of the support portion 22 between the sidewalls 36, 38, or may span less than substantially the entire length of the support portion 22 between the sidewalls 36, 38.

The second conduit segment 18b may be designed and/or selected to include any desired shape. As illustrated in FIG. 1C, the first distribution segment 40 may be a left part of an l shape and the second distribution segment 42 may be a right part of the l shape. In another example, the second conduit segment 18b may include a hub-and-spoke shape, wherein a plurality of distribution segments may radiate away from the first conduit segment 18a at a central area of the cargo vessel chamber 14h. In another example, the second conduit segment 18b may include an O shape, wherein a loop may be closed at the first conduit segment 18a disposed adjacent to the sidewall 30 of the cargo vessel chamber 14h. In another example, a combination of a hub-and-spoke shape and an O shape may provide a plurality of distribution segments that radiate away from the first conduit segment 18a at a central area of the cargo vessel chamber 14h and terminate at a closed loop that tracks the perimeter of the cargo vessel chamber. Thus, any shape is contemplated, including a step shape (e.g., horizontally, vertically), a Z shape, an L shape, and so on.

In operation, the first conduit segment 18a and the second conduit segment 18b may be disposed in the cargo vessel chamber 14h, and cargo 46 (FIG. 1A) may to be loaded into the cargo vessel chamber 14h over the first conduit segment 18a and the second conduit segment 18b. The first conduit segment 18a may protrude from a top surface of the cargo 46 and may be accessible to the fumigant system 26, while the second conduit segment 18b may be completely covered by the cargo 46.

In one example, an end of the first conduit segment 18a may terminate near the opening 28 (e.g., Z shape, L shape), discussed above. In another example, an end of the first conduit segment 18a may protrude substantially perpendicular to the top surface of the cargo 46 (e.g.,1shape, L shape), discussed above, through substantially the center of the cargo. In either case, the end of the first conduit segment 18a may be covered with a cap, e.g., when the first conduit segment 18a is not in use. The cap may include an end cap (e.g., a fitted end cap, a threaded end cap, a hinged end cap), a plug, an adhesive (e.g., tape), a thin film (e.g., wax paper), and so on. Similarly, an end of the second conduit segment 18b may be covered with a cap when open, e.g., prior to or after the second conduit segment 18b being disposed in the cargo vessel chamber 14h, prior to or after a part of the cargo 46 is loaded in the cargo vessel chamber 14h, and so on.

A fumigant may be injected to the first conduit segment 18a. As discussed above, the fumigant system 26 may be directly coupled with the first conduit segment 18a across a cover for the cargo vessel chamber 14h, the opening 28, etc., to inject the fumigant. The fumigant system 26 may also be indirectly coupled with the first conduit segment 18a through the third conduit segment 18c. The injected fumigant may then travel to be ejected from a plurality of apertures of the second conduit segment 18b to fumigate the cargo. When the fumigant is no longer injected, the first conduit segment 18a may be covered with the cap, the cargo vessel chamber 14h may be closed (e.g., with a hatch), and/or the opening 28 may be closed to transport the cargo 46. Moreover, the first conduit segment 18a may be covered after air (e.g., an air pulse) is injected to the first conduit segment 18a to evacuate the fumigation apparatus 10, to ensure that the fumigant is liberated from the apparatus 10, and/or to ensure that the fumigant is relatively evenly distributed proximate to the ejection site of the apparatus 10.

The first conduit segment 18a and the second conduit segment 18b may be removed from the cargo vessel chamber 14h when no longer in use. For example, the first conduit segment 18a and the second conduit segment 18b may be allowed to reach a destination of the cargo vessel 16c (e.g., a port) and removed after the cargo 46 is unloaded, e.g., to clean the cargo vessel chamber 14h. In this case, the first conduit segment 18a and/or the second conduit segment 18b may be reused or may be discarded. The third conduit segment 18c may also be removed from the cargo vessel 16c prior to departure or subsequent to arrival, or may remain fixed to the cargo vessel 16c for reuse.

Notably, a danger associated with fumigant toxicity may be relatively small since a fumigant may be liberated a substantial distance away from a top surface of cargo and/or workers. In addition, a number of workers may be relatively small since manual distribution or application of a sheet may not be required. Moreover, a time required to provide the fumigant may be relatively small since manual distribution or application of a sheet may not be required. Also, a peak fumigation concentration at the ejection site may be provided relatively quickly since substantially all of the fumigant may be liberated from the fumigation apparatus in a relatively short amount of time.

In addition, while forced convection (e.g., pump, suction) may be implemented, natural convection in a cargo vessel chamber may diffuse the fumigant throughout the cargo. Moreover, for example where phosphine gas is used as the fumigant, fumigation may not be hindered by environmental conditions (e.g., humidity). Also, an ordinary transport schedule may be leveraged to allow the cargo to arrive at a destination substantially free of residues, live pests, and/or fumigant. Thus, a cargo vessel may be allowed to immediately dock on arrival at a destination and the cargo may be immediately unloaded for further processing (excluding residue separation).

While a single first and a second conduit segment disposed in a single cargo vessel chamber is shown, other configurations are contemplated. For example, a plurality of first conduit segments may be disposed in a cargo vessel chamber in parallel, coupled with the same or different second conduit segments, which may be the same or different shape. In addition, a hybrid conduit segment may be implemented that includes one or more segments of a first and a second conduit segment. For example, a plurality of hybrid conduit segments having an l shape may extend substantially horizontally and may include an injection segment proximate a load portion and a distribution segment proximate a support portion. In addition, a plurality of first conduit segments may be stacked in a cargo vessel chamber in series. For example, a Z shaped first conduit segment to be coupled with a corresponding second conduit segment may be stacked with an L shaped first conduit segment to be coupled with a corresponding second conduit segment.

In this case, a T coupler may couple an intermediate segment of the Z shaped first conduit segment with it's corresponding second conduit segment and with an influent segment of the L shaped first conduit segment. Cargo may be loaded to cover the corresponding second conduit segment of the L shaped first conduit segment up to a level of the T coupler to allow coupling of Z shaped first conduit segment with it's corresponding second conduit segment. The corresponding second conduit segment of the Z shaped first conduit segment may also be rigid enough, include a shape (e.g., L shape), and/or interact with a holding device (e.g., connect with a chamber sidewall) to allow the corresponding second conduit segment of the Z shaped first conduit segment to be disposed in the cargo vessel chamber prior to the cargo being loaded.

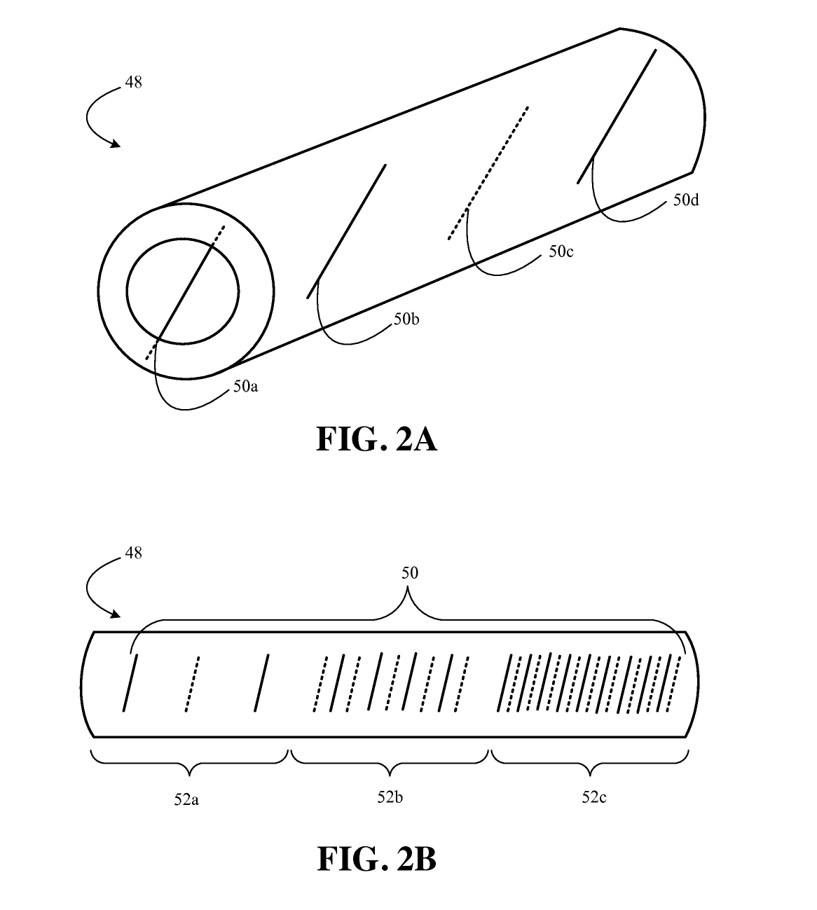

Turning now to FIGS. 2A to 2B, a conduit segment 48 is shown according an embodiment. The illustrated conduit segment 48 includes a plurality of alternately positioned apertures 50 (50a-50d) at opposite sides of the conduit segment 48. The apertures 50 may be positioned on opposing sides (e.g., sides parallel to a direction of loading, a direction of cargo weight force) of the conduit segment 48, e.g., when the conduit segment 48 is disposed on a floor of a cargo vessel chamber. As illustrated in FIG. 2A, an aperture 50a at one side of the conduit segment 48 may be alternately positioned with respect to an aperture 50b at an opposing side of the conduit segment 48. The aperture 50b may similarly be alternately positioned with respect to an aperture 50c, which may be alternately positioned with respect to an aperture 50d. Alternating the position of the apertures 50 may provide resistance to an injected fumigant, and/or may facilitate a substantially even ejection (e.g., liberation) from the conduit segment 48.

The apertures 50 may include a plurality of oblique, angled, and/or slanted apertures. For example, a plurality of slits (e.g., 1 millimeter thick, 10 centimeters long) may be positioned at an angle between approximately 10 degrees and 80 degrees relative to a direction of the conduit segment 48. As illustrated in FIG. 2A, the apertures 50 may be positioned at an approximate 45 degree angle relative to an axial plane of the conduit segment 48, which may minimize failure (e.g., collapse) and/or fatigue (e.g., warping) of the conduit segment 48 that may be caused by cargo weight on sides (e.g., top, bottom) thereof. Thus, the apertures 50 may be sufficiently fine to not substantially impact the strength (e.g., resistance to weight) of the conduit segment 48. The apertures 50 may also be designed and/or selected to include any shape, such as a round shape, a rectangular shape, and so on.

In addition, the apertures 50 may be designed and/or selected to accommodate an application. For example, a size, a density, a location, an angle, etc., of the apertures 50 may be designed and/or selected based on a location of the conduit segment 48 in a cargo vessel chamber, a cargo purity, a cargo granularity, a cargo type, and so on. In one example, an examination of a purity of the cargo may reveal that the cargo purity is very good, good, or bad. Wheat, for example, having very good purity may make bread, wheat having good purity may make bread with added ingredients, and wheat having poor purity may not be appropriate for human consumption. In this case, the wheat having very good purity may be considered to be relatively clean (e.g., relatively less powder, dirt) and the wheat having poor purity may be considered to be relatively dirty (e.g., relatively more powder, dirt). Thus, a density of apertures, a size of apertures, etc., may be adjusted based on the purity of the cargo (e.g., the more powder, the more apertures). In another example, the weight of the cargo may be considered to design and/or select a density of apertures, a size of apertures, and so on.

Similarly, the conduit segment 48 may be designed and/or selected to accommodate an application. For example, a composition, a length, a diameter, a gauge, etc., of the conduit segment 48 may be designed and/or selected based on dimensions of a cargo vessel chamber, a cargo purity, a cargo granularity, a cargo type, and so on. In one example, the conduit segment 48 may include a PVC pipe having a diameter between approximately 75 millimeters and 110 millimeters and a gauge between approximately 2 millimeters and 3 millimeters when a weight of the cargo may reach, e.g., 3000 metric tons (e.g., a barge hold, a cargo ship hold). Similarly, a length of the conduit segment 48 may be designed and/or selected to substantially match the length of a cargo vessel chamber, the height of a cargo vessel chamber, any portion thereof, and so on.

As illustrated in FIG. 2B, the conduit segment 48 may also include a plurality of stages 52 (52a-52c), wherein a density of the plurality of apertures 50 may vary according the stages 52. In one example, the conduit segment 48 may be utilized as a distribution segment of a hybrid conduit segment, wherein the density of the apertures may vary according to a distance from an injection segment. In another example, the conduit segment 48 may be the utilized as the distribution segment 40 and/or 42 (FIG. 1C), discussed above. In this case, the density of the apertures may vary according to a distance from the first conduit segment 18a (FIG. 1C), discussed above. For example, a proximal stage 52a may be adjacent to the first conduit segment 18a, a transitional stage 52b may be adjacent to the proximal stage 52a and spaced apart from the first conduit segment 18a, and a distal stage 52c may be adjacent to the transitional stage 52b and spaced apart from the first conduit segment 18a farther than the transitional stage 52b. The proximal stage 52a, the transitional stage 52b, and the distal stage 52c may all be equal lengths, such as one-third the length of the conduit segment 48.

Accordingly, approximately 10% of the apertures 50 may be disposed at the proximal stage 52a, approximately 30% of the apertures 50 may be disposed at the transitional stage 52b, and approximately 60% of the apertures 50 may be disposed at the distal stage 52c. In addition, the apertures 50 at the proximal stage 52a may be spaced apart at approximately 30 centimeter intervals, the apertures 50 at the transitional stage 52b may be spaced apart at approximately 20 centimeter intervals, and the apertures 50 at the distal stage 52c may be spaced apart at approximately 10 centimeter intervals. Varying the density of the apertures 50 may provide resistance to an injected fumigant, and/or may facilitate a substantially even ejection (e.g., liberation) from the conduit segment 48.

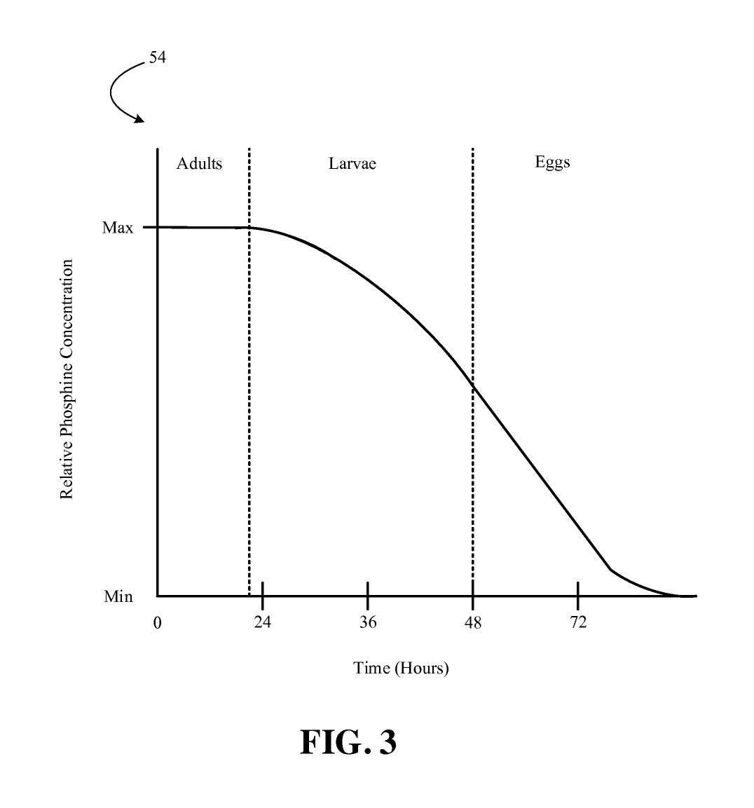

FIG. 3 shows a graph 54 of an example of a fumigant concentration profile according to an embodiment. In the illustrated example, the fumigant includes phosphine gas (PH₃). Because the fumigant methyl bromide may be phased out in some countries, PH₃ may be widely used as a cost-effective, relatively rapidly acting fumigant that does not leave residues on fumigated cargo. Although phosphine gas is more dense than air and may collect in low-lying areas of a cargo vessel chamber, natural convection may be leveraged to diffuse PH₃ throughout the cargo. However, forced convection may be utilized by using a mechanical apparatus, such as a pump, a fan, and so on.

As illustrated in FIG. 3, the concentration of PH₃ may have a maximum value at time 0 hours. In one example where PH₃ may be ejected from the second conduit segment 18b (FIG. 1C), discussed above, the concentration of PH₃ may have a maximum value at the support portion 22 (FIG. 1C), discussed above. In this case, the concentration of PH₃ may have a value of 0 at the load portion 20 (FIG. 1C), discussed above, at time 0 hours. Thus, the time 0 hours may be after a period of PH₃ injection. Notably, PH₃ may be injected and substantially completely ejected (e.g., liberated) in approximately 15 minutes, discussed below, compared to, e.g., 5 hours of work to distribute tablets and cover cargo or compared to 36 hours to degrade the tablets to provide complete liberation.

The phosphine gas may be injected to supply, for example, between approximately 0.5 grams of phosphine gas per metric ton of cargo (0.5 g PH₃/ton cargo) and 1 gram of phosphine gas per metric ton of cargo (1 g PH₃/ton cargo). For example, approximately 0.5 g PH₃/ton cargo may be injected to provide a preventive dose and approximately 1 g PH₃/ton cargo may be injected to provide a treatment dose. The preventive dose may be injected to prevent a pest from infesting the cargo in transit. The treatment dose may be injected to treat a pest that has infested the cargo prior to transit. Any desired dose to prevent an infestation and/or to treat an infestation is contemplated.

In one example, a treatment dose of approximately 2 g PH₃/ton cargo may be provided, e.g., when cost is not a concern. In another example, a dose may be determined using the relation A₁/B₁=A₂B₂, where A₁ is approximately 1 PH₃/ton cargo, B₁ is approximately 720 parts per million (ppm) PH₃, B₂ is a desired ppm (e.g., based on dose type, pest type), and A₂ is the selected dose. For example, data from readily available sources such as Hartsell et al. (Mortality of Eight Species of Stored Product Insects from a Mixture of Hydrogen Phosphide and Carbon Dioxide Contained in Gas Cylinders at Selected Temperatures and Exposure Times, DFA of California: 2003), summarized in Table 1, may be utilized to determine a desired ppm to calculate a selected dose. As illustrated in Table 1, a selected treatment dose may be, e.g., approximately three times an effective dose (e.g., 1 g PH₃/ton cargo for approximately 720 ppm).

TABLE 1
Example: Example PH₃ Dose for Example Insect Species.

| | | Exposed for 24 Hours at 26.7° C. | | | |
|---|---|---|---|---|---|
| | | (80° F.) | | | |
| | ppm | Percent (%) Mortality | | | |
| Insect species | PH3 | eggs | larvae | adults | pupae |
| Amyelois transitella | 250 | 0-78 | 100 | 100 | 100 |
| Navel Orange Worm | 500 | 20-80 | 100 | 100 | 100 |
| | 1000 | 70-100 | 100 | 100 | 100 |
| Orzaephilus surinamensis | 250 | 100 | 97-100 | 100 | 100 |
| Saw-toothed Grain Beetle | 500 | 100 | 100 | 100 | 100 |
| | 1000 | 100 | 100 | 100 | 100 |
| Tribolium castaneum | 250 | 90-100 | 100 | 100 | 100 |
| Red Flour Beetle | 500 | 100 | 100 | 100 | 100 |
| | 1000 | 100 | 100 | 100 | 100 |
| Tribolium confusum | 250 | 59-80 | 100 | 100 | 89-95 |
| Confused Flour Beetle | 500 | 83-100 | 100 | 100 | 89-98 |
| | 1000 | 100 | 100 | 100 | 94-100 |
| Lasioderma serricorne | 250 | 87-94 | 100 | 100 | 100 |
| Cigarette Beetle | 500 | 87-96 | 100 | 100 | 100 |
| | 1000 | 96-100 | 100 | 100 | 100 |
| Carpophilus hemipterus | 250 | 100 | 100 | 100 | 100 |
| Dried Fruit Beetle | 500 | 100 | 100 | 100 | 100 |
| | 1000 | 100 | 100 | 100 | 100 |
| Plodia interpunctella | 250 | 89-96 | 95-100 | 100 | 100 |
| Indian Meal Moth | 500 | 90-100 | 97-99 | 100 | 100 |
| | 1000 | 95-100 | 100 | 100 | 100 |

In operation, a sample may be taken and analyzed to determine whether a preventive dose or the treatment dose is needed. The sample (e.g., 10 samples) may be independently passed through a filter and a preventive dose (e.g., approximately 0.5 g PH₃/ton cargo) may be selected if no pests (e.g., adults, larvae, eggs) are detected. If a predetermined number of pests are detected that indicate a low level of infestation (e.g., 1 pest), a relatively low treatment dose may be selected. If a predetermined number of pests are detected (e.g., 20 pests) that indicates a high level of infestation, a relatively high treatment dose may be selected (e.g., approximately 1 g PH₃/ton cargo).

In addition, the time of injection may be designed and/or selected as needed. For example, Horn Diluphos System® (Fosfoquim S.A. Corp.) (HDS) 80 may provide a gas flow rate of approximately 19 g PH₃/minute, HDS 200 may provide a gas flow rate of approximately 47 g PH₃/minute, HDS 800 may provide a gas flow rate of approximately 190 g PH₃/minute, and so on. Where a cargo vessel is relatively small (e.g., a bin), an HDS 30 may be utilized for volumes up to approximately 1 m³ or 35 cubic feet at a flow rate of approximately 6 g PH₃/minute. In this case, a PH₃ nozzle may be used together with a flexible hose to inject the PH₃. In addition, the same HDS may be used sequentially and/or in parallel to fumigate cargo in a plurality of cargo vessel chambers, a plurality of HDS may be used to fumigate cargo in a plurality of cargo vessel chambers, and so on. Thus, the gas flow rate may be provided as needed.

Thus, the time for injection of a preventive dose of approximately 0.5 g PH₃/ton cargo for Z ton of cargo using the HDS 200 may be determined using the relation (0.5 g PH₃/ton cargo)(Z ton cargo)/47 g PH₃/minute=X minute. Similarly, the time for injection of a treatment dose of approximately 1 g PH₃/ ton cargo for Z ton of cargo using the HDS 200 may be determined using the relation (1 g PH₃/ton cargo)(Z ton cargo)/47 g PH₃/minute=X minute. In one example where the cargo weighs 2,700 metric tons and the HDS 800 is used to provide a treatment dose of approximately 1 g PH₃/ton cargo, the time of injection may be approximately 14 minutes.

In addition, an apparent relative density of cargo may be considered. For example, ambient air may be injected at a predetermined rate (e.g., 500 cubic meters per hour) for a treatment dose and/or a preventive dose to increase injection pressure when the density of the cargo is relatively high. In this case, the additional pressure may overcome resistive force caused by dust (e.g., grain dust) formed from broken bulk items (e.g., broken grains) and/or relatively smaller bulk items (e.g., smaller particles). For example, a predetermined amount of air at a flow rate of approximately 500 m³ air/hour may be injected to provide additional pressure for cargo that is relatively dense (e.g., Wheat, from http ://www*fao*org/docrep/x5041s/x5041s09*htm, Table 2).

TABLE 2
Example: Example Density for Example Cargo.

| Solid Agricultural Products | Density (kg/m³) |
|---|---|
| Alfalfa, grains | 750-800 |
| Cotton, grains with fiber | 420 |
| Cotton, grain not tight | 100-120 |
| Rice husk | 500-630 |
| Rice, sheaves | 80-120 |
| Milled Rice | 800-850 |
| Rice, husked | 700-750 |
| Oats | 500-540 |
| Peanut in shell for oil | 370-400 |
| Peanut without shell | 600-620 |
| Peanut with shell, direct consumption | 270-300 |
| Cocoa, fresh beans | 900 |
| Cocoa, fermented beans | 775 |
| Cocoa, dry beans | 635 |
| Coffee, fresh beans | 620 |
| Coffee, commercial | 715 |
| Coffee, dry beans | 450 |
| Barley | 550-690 |
| Beans, grains | 750-850 |
| Peas | 800-880 |
| Flax | 600-680 |
| Corn, grains | 700-820 |
| Corn, peeled ears | 450 |
| Malt | 530-600 |
| Millet | 700 |
| Soybeans, grains | 720-800 |
| Sorghum, grain | 670-760 |
| Wheat | 750-840 |
| Flour | 500-800 |

As illustrated in FIG. 3, there may be a negligible decline in fumigant concentration at the ejection (e.g., liberation) area for approximately 24 hours, e.g., when natural convection diffuses the fumigant through the cargo. For example, there may be a 24-hour natural convection cycle with two opposing convection currents. Thus, where approximately 1 g PH₃/ton cargo is injected at a floor of a cargo vessel chamber, approximately 0 ppm may be provided at an upper surface of the cargo at hour 0, approximately 2 ppm may be provided at hour 2, approximately 8 ppm may be provided at hour 8, and approximately 200 ppm may be provided at hour 24. Notably, such a ppm concentration of PH₃ may already be effective to prevent and/or treat a pest infestation.

As exposure to the effective concentration of PH₃ continues (e.g., a travel schedule may be more than three days), the concentration profile may change inversely with respect to the surface of the cargo. Thus, approximately 400 ppm may be provided at the upper surface of the cargo at hour 36, approximately 700 ppm may be provided at hour 72, and so on. Meanwhile, infestation from different pests and/or different stages of pest development may be eliminated. Accordingly, a pest disposed anywhere in the cargo may be exposed for a sufficient amount of time and to a sufficient effective concentration of PH₃ to prevent and/or to treat an infestation. In addition, PH₃ may escape from the top surface of the cargo in transit and react with atmospheric air or light to generate a non-toxic form (e.g., trace amount of phosphoric acid is non-toxic). Thus, cargo may be unloaded immediately upon arrival at a destination for further processing (e.g., filtering, packaging, mixing, cooking) without the danger and/or presence of residues, un-liberated fumigant, trapped fumigant, toxic amount of fumigant, and so on.

While example pests and example cargo have been provided, any pests and/or cargo are contemplated. For example, pests may include a rodent, a Cigarette Beetle, Drugstore Beetle, a Spider Beetle, a Cocao Weevil, a Bamboo Borer, a Larger Grain Borer, a Lesser Grain Borer, a Ham Beetle, a Bean Weevil, a Bruchid Beetle, a Pea Weevil, a Cowpea Weevil, a Groundnut Bruchid, a Mexican Bean Weevil, a Grain Weevil, a Rice Weevil, a Variegated Carpet Beetles, a Australian Carpet Beetle, a Black Carpet Beetle, a Black Larder Beetle, Larder Beetle, a Hide Beetle, a Larger Cabinet Beetle, a Khapra Beetle, a Warehouse Beetle, a Histerid Beetle, a Flat Grain Beetle, and so on. In addition, cargo may include fruit, wood, tobacco, nuts, herbs, spices, seeds, grains, grain products, dried material of animal origin, dried material of vegetable origin, dried root crops, bamboo, rattan, dried cassava, cereal grains, sorghum, lentils, woolen goods, skins, hides, dried fish, packaged goods, processed goods, and so on.

Moreover, one or more aspects of providing and/or implementing a fumigation apparatus, such as the fumigation apparatus 10 (FIGS. 1A-1C), discussed above, may be implemented in one or more modules as a set of logic instructions stored in a machine- or computer-readable storage medium such as random access memory (RAM), read only memory (ROM), programmable ROM (PROM), flash memory, etc., as configurable logic such as, for example, programmable logic arrays (PLAs), field programmable gate arrays (FPGAs), complex programmable logic devices (CPLDs), as fixed-functionality logic hardware using circuit technology such as, for example, application specific integrated circuit (ASIC), complementary metal oxide semiconductor (CMOS) or transistor-transistor logic (TTL) technology, or any combination thereof

For example, computer program code to carry out operations to provide one or more aspects (e.g., type, configuration, location, size, shape, aperture density, angle, location) of the conduit segment 48 (FIGS. 2A-2B), discussed above, and/or one or more aspects (e.g., apparatus configuration, location, fumigant dose, additional air) for the concentration profile 54 (FIG. 3), discussed above, may be written in any combination of one or more programming languages, including an object oriented programming language such as C++ or the like and conventional procedural programming languages, such as the “C” programming language or similar programming languages. Moreover, in some implementations, various aspects could be implemented as embedded logic using any of the aforementioned circuit technologies. Thus, in one example, a configuration of a fumigation apparatus may be designed and/or selected, and/or a relation may be solved, by a processor (e.g., hardware processor) using instructions stored in memory and/or storage, using data stored in memory and/or storage (e.g., from a data structure such as a table), using data from a user interface to specify parameters (e.g., cargo, travel time, pest type, fumigant type, purpose of dose, cargo vessel chamber dimensions), and so on.

### EXAMPLE EXPERIMENTS

### Example Experiment 1

A fumigation apparatus, such as the fumigation apparatus 10 (FIGS. 1A-1C), was provided in a barge hatch at a source shipping port that was subsequently loaded with 2,700 metric tons of corn kernels (cargo). A dose of 2,600 g PH₃ was injected (approximately 1.03 g PH₃/ton cargo) without the use of a turbine (e.g., fan). A PH₃ sensor was then used to measure the air quality immediately above the surface of the cargo and the gas concentration the approximately 1 meter below the surface of the cargo (using a probe) at predetermined time intervals. The first reading at 14 hours post injection showed 0 ppm PH₃ above the top surface and 2000 ppm PH₃ below the top surface. The second reading at 32 hours post injection showed 31 ppm PH₃ above the top surface and 1,500 ppm PH₃ below the top surface. The third reading at 56 hours post injection showed 52 ppm PH₃ above the top surface and 1,356 ppm PH₃ below the top surface. The fifth reading at 80 hours post injection showed 108 ppm PH₃ above the top surface and 1,300 ppm PH₃ below the top surface. The sixth reading, conducted approximately two weeks later upon arrival at a destination shipping port, showed 0 ppm PH₃ above the top surface of the cargo and 0 ppm PH₃ below the top surface of the cargo. Moreover, the cargo was free of residues and live pests.

### Example Experiment 2

On the same day as Experiment 1, a fumigation apparatus, such as the fumigation apparatus 10 (FIGS. 1A-1C), was provided in a barge hatch at the source shipping port that was subsequently loaded with 2,700 metric tons of corn kernels (cargo). A dose of 2,200 g PH₃ was injected (approximately 0.814 g PH₃/ton cargo) with a turbine (e.g., fan) to push the PH₃. The PH₃ sensor was then used to measure the air quality immediately above the surface of the cargo and the gas concentration the approximately 1 meter below the surface of the cargo (using a probe) at predetermined time intervals. The first reading at 14 hours post injection showed 0 ppm PH₃ above the top surface and 1,700 ppm PH₃ below the top surface. The second reading at 32 hours post injection showed 502 ppm PH₃ above the top surface and 1,025 ppm PH₃ below the top surface. The third reading at 56 hours post injection showed 580 ppm PH₃ above the top surface and 1,000 ppm PH₃ below the top surface. The fifth reading at 80 hours post injection showed 660 ppm PH₃ above the top surface and 112 ppm PH₃ below the top surface. The sixth reading, conducted approximately two weeks later upon arrival at the destination shipping port, showed 0 ppm PH₃ above the top surface of the cargo and 0 ppm PH₃ below the top surface of the cargo. Moreover, the cargo was free of residues and live pests.

### Example Experiment 3

The day following Experiment 1 and Experiment 2, a fumigation apparatus, such as the fumigation apparatus 10 (FIGS. 1A-1C), was provided in a barge hatch at the source shipping port that was subsequently loaded with 2,700 metric tons of corn kernels (cargo). A dose of 1,700 g PH₃ was injected (approximately 0.620 g PH₃/ton cargo) without auxiliary turbine and only with the air flow of the phosphine mixture delivery equipment itself (e.g., approximately 200 m³/hour). The PH₃ sensor was then used to measure the air quality immediately above the surface of the cargo and the gas concentration the approximately 1 meter below the surface of the cargo (using a probe) at predetermined time intervals. The first reading at 14 hours post injection showed 0 ppm PH₃ above the top surface and 1,452 ppm PH₃ below the top surface. The second reading at 32 hours post injection showed 150 ppm PH₃ above the top surface and 1,300 ppm PH₃ below the top surface. The third reading at 56 hours post injection showed 225 ppm PH₃ above the top surface and 1,380 ppm PH₃ below the top surface. The fifth reading at 80 hours post injection showed 270 ppm PH₃ above the top surface and 1,120 ppm PH₃ below the top surface. The sixth reading, conducted approximately two weeks later upon arrival at the destination shipping port, showed 0 ppm PH₃ above the top surface of the cargo and 0 ppm PH₃ below the top surface of the cargo. Moreover, the cargo was free of residues and live pests.

### Example Experiment 4

The same day as Experiment 3, and eight days thereafter, nine barges were loaded and fumigated in a similar manner as in Experiment 3 to test repeatability. The final reading for each of the nine additional barges, conducted approximately two weeks later upon arrival at the destination shipping port, showed 0 ppm PH₃ above the top surface of the cargo and 0 ppm PH₃ below the top surface of the cargo. Moreover, the cargo was free of residues and live pests.

### ADDITIONAL NOTES AND EXAMPLES

Example 1 may include a fumigation apparatus comprising a first conduit segment to extend between a load portion of a cargo vessel chamber and a support portion of the cargo vessel chamber opposite the load portion, and a second conduit segment coupled with the first conduit segment to extend over the support portion between opposing sidewalls of the cargo vessel chamber, wherein the second conduit segment is to include a plurality of apertures to allow a fumigant that is to be injected to the first conduit segment to be ejected from the second conduit segment.

Example 2 may include the apparatus of Example 1, wherein the cargo vessel chamber is to include a cargo hold of one or more of a barge and a ship.

Example 3 may include the apparatus of any one of Examples 1 to 2, wherein the first conduit portion is to be accessible via one or more of a manually movable cover and an automatically movable cover for the cargo vessel chamber.

Example 4 may include the apparatus of any one of Examples 1 to 3, further including a third conduit segment to be disposed external to the cargo vessel chamber to couple the first conduit segment with a fumigant system.

Example 5 may include the apparatus of any one of Examples 1 to 4, wherein the first conduit segment is to include an influent segment to couple the first conduit segment with a fumigant system, an intermediate segment to extend substantially vertically between the load portion and the support portion, and a coupler segment to couple the first conduit segment with the second conduit segment, wherein the fumigant is to be injected to the influent segment and is to unidirectionally flow out of the coupler segment to the second conduit segment.

Example 6 may include the apparatus of any one of Examples 1 to 5, wherein the influent segment is to be accessible across one or more of a cover for the cargo vessel chamber and an opening at a sidewall of the cargo vessel chamber, and wherein the intermediate segment is to be disposed at one or more of the sidewall of the cargo vessel chamber and proximate to a central area of the cargo vessel chamber.

Example 7 may include the apparatus of any one of Examples 1 to 6, further including a cap to cover the first conduit segment when the fumigant is no longer to be injected.

Example 8 may include the apparatus of any one of Examples 1 to 7, wherein one or more of the first conduit segment and the second conduit segment is to include one or more of a Z shape, an L shape, an l shape, an O shape, a C shape, an E shape, a V shape, an M shape, a step shape, and a hub-and-spoke shape.

Example 9 may include the apparatus of any one of Examples 1 to 8, wherein the second conduit segment is to be disposed on a floor of the cargo vessel chamber.

Example 10 may include the apparatus of any one of Examples 1 to 9, wherein the second conduit segment is to include a distribution segment to extend from the first conduit segment.

Example 11 may include the apparatus of any one of Examples 1 to 10, further including a first distribution segment to extend from the first conduit segment in a substantially horizontal direction towards a first sidewall of the cargo vessel chamber, and a second distribution segment to extend from the first conduit segment in substantially horizontal direction towards a second sidewall opposite the first sidewall.

Example 12 may include the apparatus of any one of Examples 1 to 11, wherein the second conduit segment is to include a plurality of stages, and wherein a density of the plurality of apertures is to vary according to one or more of a distance from the first conduit segment and a purity of a bulk item to be fumigated.

Example 13 may include the apparatus of any one of Examples 1 to 12, wherein the plurality of stages are to include a proximal stage, a transitional stage, and a distal stage of equal lengths.

Example 14 may include the apparatus of any one of Examples 1 to 13, wherein approximately 10% of the plurality of apertures are to be disposed at the proximal stage, approximately 30% of the plurality of apertures are to be disposed at the transitional stage, and approximately 60% of the plurality of apertures are to be disposed at the distal stage.

Example 15 may include the apparatus of any one of Examples 1 to 14, wherein the plurality of apertures at the proximal stage are to be spaced apart at approximately 30 centimeter intervals, the plurality of apertures at the transitional stage are to be spaced apart at approximately 20 centimeter intervals, and the plurality of apertures at the distal stage are to be spaced apart at approximately 10 centimeter intervals.

Example 16 may include the apparatus of any one of Examples 1 to 15, wherein the second conduit segment is to include a Polyvinyl chloride (PVC) pipe having a diameter between approximately 75 millimeters and 110 millimeters and a gauge between approximately 2 millimeters and 3 millimeters.

Example 17 may include the apparatus of any one of Examples 1 to 16, wherein the plurality of apertures are to include a plurality of alternately positioned apertures at opposite sides of the second conduit segment.

Example 18 may include the apparatus of any one of Examples 1 to 17, wherein the plurality of alternately positioned apertures are to include a plurality of slits at an angle between approximately 10 degrees and 80 degrees relative to a direction of the second conduit segment.

Example 19 may include the apparatus of any one of Examples 1 to 18, further including cargo to be loaded in the cargo vessel chamber over the first conduit segment and the second conduit segment.

Example 20 may include the apparatus of any one of Examples 1 to 19, wherein the cargo is to include one or more of wheat, maize, rice, and fruit.

Example 21 may include the apparatus of any one of Examples 1 to 20, wherein the fumigant is to include phosphine gas.

Example 22 may include the apparatus of any one of Examples 1 to 21, wherein the phosphine gas is to be injected to supply between approximately 0.5 grams of phosphine gas per metric ton of cargo and 1 gram of phosphine gas per metric ton of cargo.

Example 23 may include the apparatus of any one of Examples 1 to 22, wherein approximately 0.5 grams of phosphine gas per metric ton of cargo is to be injected to provide a preventive dose and approximately 1 gram of phosphine gas per metric ton of cargo is to be injected to provide a treatment dose.

Example 24 may include the apparatus of any one of Examples 1 to 23, wherein natural convention in the cargo vessel chamber is to diffuse the fumigant throughout cargo.

Example 25 may include a method to fumigate cargo comprising providing a first conduit segment extending between a load portion of a cargo vessel chamber and a support portion of the cargo vessel chamber opposite the load portion, providing a second conduit segment coupled with the first conduit segment extending over the support portion between opposing sidewalls of the cargo vessel chamber, wherein the second conduit segment includes a plurality of apertures, loading cargo to the cargo vessel chamber to be disposed over the first conduit system and the second conduit system, and injecting a fumigant to the first conduit segment to be ejected from the plurality of apertures of second conduit segment to fumigate the cargo.

Example 26 may include the method of Example 25, wherein the cargo vessel chamber includes a cargo hold of one or more of a barge and a ship.

Example 27 may include the method of any one of Examples 25 to 26, further including accessing the first conduit portion via one or more of a manually movable cover and an automatically movable cover for the cargo vessel chamber.

Example 28 may include the method of any one of Examples 25 to 27, further including providing a third conduit segment disposed external to the cargo vessel chamber to couple the first conduit segment with a fumigant system.

Example 29 may include the method of any one of Examples 25 to 28, further including providing an influent segment of the first conduit segment coupling the first conduit segment with a fumigant system, providing an intermediate segment of the first conduit segment extending substantially vertically between the load portion and the support portion, and providing a coupler segment coupling the first conduit segment with the second conduit segment, wherein the fumigant is injected to the influent segment and unidirectionally flows out of the coupler segment to the second conduit segment.

Example 30 may include the method of any one of Examples 25 to 29, further including accessing the influent portion across one or more of a cover for the cargo vessel chamber and an opening at a sidewall of the cargo vessel chamber, and providing an intermediate segment disposed at one or more of the sidewall of the cargo vessel chamber and proximate to a central area of the cargo vessel chamber.

Example 31 may include the method of any one of Examples 25 to 30, further including covering the first conduit segment with a cap when the fumigant is no longer injected.

Example 32 may include the method of any one of Examples 25 to 31, wherein one or more of the first conduit segment and the second conduit segment includes one or more of a Z shape, an L shape, an l shape, an O shape, a C shape, an E shape, a V shape, an M shape, a step shape, and a hub-and-spoke shape.

Example 33 may include the method of any one of Examples 25 to 32, further including disposing the second conduit segment on a floor of the cargo vessel chamber.

Example 34 may include the method of any one of Examples 25 to 33, further including providing a distribution segment of the second conduit segment extending from the first conduit segment.

Example 35 may include the method of any one of Examples 25 to 34, further including providing a first distribution segment of the second conduit segment extending from the first conduit segment in a substantially horizontal direction towards a first sidewall of the cargo vessel chamber, and providing a second distribution segment of the second conduit segment extending from the first conduit segment in substantially horizontal direction towards a second sidewall opposite the first sidewall.

Example 36 may include the method of any one of Examples 25 to 35, further including providing a plurality of stages in the second conduit segment, and varying a density of the plurality of apertures according to one or more of a distance from the first conduit segment and a purity of a bulk item to be fumigated.

Example 37 may include the method of any one of Examples 25 to 36, wherein the plurality of stages includes a proximal stage, a transitional stage, and a distal stage of equal lengths.

Example 38 may include the method of any one of Examples 25 to 37, further including disposing approximately 10% of the plurality of apertures at the proximal stage, disposing approximately 30% of the plurality of apertures at the transitional stage, and disposing approximately 60% of the plurality of apertures at the distal stage.

Example 39 may include the method of any one of Examples 25 to 38, further including spacing apart the plurality of apertures at the proximal stage at approximately 30 centimeter intervals, spacing apart the plurality of apertures at the transitional stage at approximately 20 centimeter intervals, and spacing apart the plurality of apertures at the distal stage at approximately 10 centimeter intervals.

Example 40 may include the method of any one of Examples 25 to 39, wherein the second conduit segment includes a Polyvinyl chloride (PVC) pipe having a diameter between approximately 75 millimeters and 110 millimeters and a gauge between approximately 2 millimeters and 3 millimeters.

Example 41 may include the method of any one of Examples 25 to 40, wherein the plurality of apertures include a plurality of alternately positioned apertures at opposite sides of the second conduit segment.

Example 42 may include the method of any one of Examples 25 to 41, wherein the plurality of alternately positioned apertures include a plurality of slits at an angle between approximately 10 degrees and 80 degrees relative to a direction of the second conduit segment.

Example 43 may include the method of any one of Examples 25 to 42, wherein the cargo includes one or more of wheat, maize, rice, and fruit.

Example 44 may include the method of any one of Examples 25 to 43, wherein the fumigant includes phosphine gas.

Example 45 may include the method of any one of Examples 25 to 44, further including injecting the phosphine gas to supply between approximately 0.5 grams of phosphine gas per metric ton of cargo and 1 gram of phosphine gas per metric ton of cargo.

Example 46 may include the method of any one of Examples 25 to 45, further including injecting approximately 0.5 grams of phosphine gas per metric ton of cargo to provide a preventive dose, and injecting approximately 1 gram of phosphine gas per metric ton of cargo to provide a treatment dose.

Example 47 may include the method of any one of Examples 25 to 46, further including allowing natural convection in the cargo vessel chamber to diffuse the fumigant throughout cargo.

Example 48 may include a system comprising a cargo vessel and the apparatus of any one of Examples 1 to 24.

Example 49 may include a system comprising a cargo vessel chamber and a fumigated composition disposed in the cargo vessel chamber, wherein the fumigated composition is to include phosphine gas when the cargo vessel chamber is to be closed for transport at a cargo vessel source, and wherein the fumigated composition is to be substantially free of a live pest, a toxic residue, and the phosphine gas when the cargo vessel chamber is to be opened for unloading at a cargo vessel destination.

Example 50 may include a fumigated composition, wherein the fumigated composition is to include phosphine gas when a cargo vessel chamber is to be closed for transport at a cargo vessel source, and wherein the fumigated composition is to be substantially free of a live pest, a toxic residue, and the phosphine gas when the cargo vessel chamber is to be opened for unloading at a cargo vessel destination.

Example 51 may include a fumigated composition substantially free of a live pest, a toxic residue, and phosphine gas, wherein the fumigated composition is to include a retractable conduit segment disposed therein.

Example 52 may include at least one computer readable storage medium comprising one or more instructions that when executed on a computing device cause the computing device to provide and/or implement any one of Examples 1 to 51.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

It should also be understood that the indefinite articles “a” or “an” carry the meaning of “one or more” or “at least one”. In addition, as used in this application, a list of items joined by the terms “one or more of”, “at least one of” can mean any combination of the listed terms. For example, the phrases “one or more of A, B and C” and “one or more of A, B or C” can mean A; B; C; A and B; A and C; B and C; or A, B and C. Similarly, a list of terms joined by the term “and so on” can mean the list is not an exhaustive list and may be any combination of the listed terms. For example, the phrase “A, B, C, and so on” can mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. An apparatus comprising:
a first conduit segment to extend between a load portion of a cargo vessel chamber and a support portion of the cargo vessel chamber opposite the load portion;
a second conduit segment coupled with the first conduit segment to extend over the support portion between opposing sidewalls of the cargo vessel chamber, wherein the second conduit segment is to include a plurality of apertures to allow a fumigant that is to be injected to the first conduit segment to be ejected from the second conduit segment.

2. The apparatus of claim 1, wherein the cargo vessel chamber is to include a cargo hold of one or more of a barge and a ship.

3. The apparatus of claim 1, further including a third conduit segment to be disposed external to the cargo vessel chamber to couple the first conduit segment with a fumigant system.

4. The apparatus of claim 1, wherein the first conduit segment is to include:
an influent segment to couple the first conduit segment with a fumigant system;
an intermediate segment to extend substantially vertically between the load portion and the support portion; and
a coupler segment to couple the first conduit segment with the second conduit segment, wherein the fumigant is to be injected to the influent segment and is to unidirectionally flow out of the coupler segment to the second conduit segment.

5. The apparatus of claim 1, wherein the second conduit segment is to include a distribution segment to extend from the first conduit segment.

6. The apparatus of claim 5, further including:
a first distribution segment to extend from the first conduit segment in a substantially horizontal direction towards a first sidewall of the cargo vessel chamber; and
a second distribution segment to extend from the first conduit segment in substantially horizontal direction towards a second sidewall opposite the first sidewall.

7. The apparatus of claim 1, wherein the second conduit segment is to include a plurality of stages, and wherein a density of the plurality of apertures is to vary according to one or more of a distance from the first conduit segment and a purity of a bulk item to be fumigated.

8. The apparatus of claim 7, wherein the plurality of stages are to include a proximal stage, a transitional stage, and a distal stage of equal lengths.

9. The apparatus of claim 8, wherein approximately 10% of the plurality of apertures are to be disposed at the proximal stage, approximately 30% of the plurality of apertures are to be disposed at the transitional stage, and approximately 60% of the plurality of apertures are to be disposed at the distal stage.

10. The apparatus of claim 8, wherein the plurality of apertures at the proximal stage are to be spaced apart at approximately 30 centimeter intervals, the plurality of apertures at the transitional stage are to be spaced apart at approximately 20 centimeter intervals, and the plurality of apertures at the distal stage are to be spaced apart at approximately 10 centimeter intervals.

11. The apparatus of claim 1, wherein the plurality of apertures are to include a plurality of alternately positioned apertures at opposite sides of the second conduit segment.

12. The apparatus of claim 11, wherein the plurality of alternately positioned apertures are to include a plurality of slits at an angle between approximately 10 degrees and 80 degrees relative to a direction of the second conduit segment.

13. The apparatus of claim 1, wherein the fumigant is to include phosphine gas.

14. A method comprising:
providing a first conduit segment extending between a load portion of a cargo vessel chamber and a support portion of the cargo vessel chamber opposite the load portion;
providing a second conduit segment coupled with the first conduit segment extending over the support portion between opposing sidewalls of the cargo vessel chamber, wherein the second conduit segment includes a plurality of apertures;
loading cargo to the cargo vessel chamber to be disposed over the first conduit system and the second conduit system; and
injecting a fumigant to the first conduit segment to be ejected from the plurality of apertures of second conduit segment to fumigate the cargo.

15. The method of claim 14, further including providing a third conduit segment disposed external to the cargo vessel chamber to couple the first conduit segment with a fumigant system.

16. The method of claim 14, further including:
providing an influent segment of the first conduit segment coupling the first conduit segment with a fumigant system;
providing an intermediate segment of the first conduit segment extending substantially vertically between the load portion and the support portion; and
providing a coupler segment coupling the first conduit segment with the second conduit segment, wherein the fumigant is injected to the influent segment and unidirectionally flows out of the coupler segment to the second conduit segment.

17. The method of claim 14, further including:
providing a first distribution segment of the second conduit segment extending from the first conduit segment in a substantially horizontal direction towards a first sidewall of the cargo vessel chamber; and
providing a second distribution segment of the second conduit segment extending from the first conduit segment in substantially horizontal direction towards a second sidewall opposite the first sidewall.

18. The method of claim 14, further including:
providing a plurality of stages in the second conduit segment; and
varying a density of the plurality of apertures according to one or more of a distance from the first conduit segment and a purity of a bulk item to be fumigated.

19. The method of claim 14, further including:
injecting approximately 0.5 grams of phosphine gas per metric ton of cargo to provide a preventive dose; and
injecting approximately 1 gram of phosphine gas per metric ton of cargo to provide a treatment dose.

20. A system comprising:
a cargo vessel including a cargo vessel chamber;
a first conduit segment to extend between a load portion of the cargo vessel chamber and a support portion of the cargo vessel chamber opposite the load portion;
a second conduit segment coupled with the first conduit segment to extend over the support portion between opposing sidewalls of the cargo vessel chamber, wherein the second conduit segment is to include a plurality of apertures to allow a fumigant that is to be injected to the first conduit segment to be ejected from the second conduit segment.
